(19) United States
(12) Patent Application Publication
(10) Pub. No.: US 2023/0085145 A1
(43) Pub. Date: Mar. 16, 2023

(54) ULTRA-HIGH MOLECULAR WEIGHT POLYETHYLENE POWDER HAVING IMPROVED SWELLING PERFORMANCE

(71) Applicant: SABIC GLOBAL TECHNOLOGIES B.V., BERGEN OP ZOOM (NL)

(72) Inventors: Thomas LANGSTRAAT, Leuven (BE); Priya GARG, Vaals (NL); Shaneesh VADAKE KULANGARA, Veldhoven (NL); Jens PANITZKY, Dorsten (DE)

(21) Appl. No.: 17/919,807

(22) PCT Filed: May 10, 2021
(86) PCT No.: PCT/EP2021/062256

§ 371 Date: Oct. 19, 2022

(30) Foreign Application Priority Data
May 14, 2020 (EP) 20174698.9

(51) Int. Cl. C08F 10/02; C08L 23/08; C08L 23/06; C08L 91/06

(52) U.S. Cl. CPC C08F 10/02; C08L 23/0815; C08L 23/06; C08L 91/06; C08F 2410/06

(57) ABSTRACT

The present invention relates to an ultra-high molecular weight polyethylene (UHMWPE) powder having a BET specific surface area of ≥0.50 m²/g as determined in accordance with ISO 9277 (2010). Such UHMWPE powder allows for preparation of a gel solution comprising the powder to a desired swelling ratio at moderate temperatures within a reduced swelling period.

The present invention relates to an ultra-high molecular weight polyethylene with improved properties for use in the manufacturing of high-strength polyethylene fibres via gel-spinning technologies. The invention further also relates to a process for production of an ultra-high molecular weight polyethylene gel.

In the context of the present invention, ultra-high molecular weight polyethylene is also referred to as UHMWPE. As is known and used commonly in the art, UHMWPE are polyethylenes having a molecular weight of more than 1,000,000 g/mol. For example, UHMWPE as in the present invention may for example have viscosity-average molecular weight (Mᵥ) of ≥2.0·10⁶ g/mol, as determined in accordance with ASTM D4020 (2011).

UHMWPE powders, also referred to herein as UH powders, find amongst others their use in the manufacturing of fibres. Fibres that are produced from UHMWPE powders typically exhibit very high strength, and by virtue of this high strength, are typically used as high-performance fibres. Examples of such high-performance fibres are load- or force-bearing fibres. Applications of such fibres include applications of singular fibres, such as in for example fishing lines, applications of in ropes and nets constituted of multiple fibers, such as for example in fishing nets, and in ropes for securing marine subaqueous structures, applications in nonwoven textiles such as cloths for filters, and applications in woven textiles such as impact absorbing woven structures, for example used in impact-absorbing composites.

In addition to their strength, fibres produced from UHMWPE, herein also referred to as UH fibres, also exhibit a very low weight with regard to the strength of the fibre, and are particularly inert. Furthermore, such fibres exhibit very little influence of temperature on their properties. For amongst others those reasons, UH fibres are particularly attractive for many uses and employed abundantly.

The manufacturing of UH fibres may be done via a spinning process. Due to the high molecular weight of the UHMWPE polymer, however, such spinning cannot be performed via conventional melt spinning processes, wherein the material that is to be spun into fibres is heated to above its melting point, forced though an aperture, typically a cylindrical aperture, stretched to a certain degree of stretching, and cooled to below the melting point to solidify the materials into a fibre. When UHMWPE polymer material of the molecular weight as indicated above would be subjected to such process, it would on the one hand retain such viscosity that forcing through an aperture would not be possible, as well as degradation due to high temperature exposure may occur.

Commonly, the production of UH fibres from UH powder is done via gel spinning processes. In such process, a solvent is used to dissolve the powder particles to such degree that a gel spinning solution is formed, which subsequently is forced through an aperture and stretched to form a fibre. By subsequent removal of the solvent, a fibre is obtained that, depending on the conditions of the gel formation and of the spinning process, has certain desirable material characteristics.

In order to ensure a swift and effective gel spinning process, it is paramount that the preparation of the gel spinning solution is performed optimally. The preparation of this gel spinning solution involves two stages, being a first stage of swelling of the UH powder, followed by dissolution.

During the swelling stage, diffusion is to occur of a solvent through the polymeric chains of the UHMWPE. By this diffusion, the distance between the polymeric chains will increase, resulting in reduced physical bond between the molecules, as they form a gel-type body of matter. This gel-type matter may be subjected to physical processing, such as shaping processes, allowing to convert the solid UHMWPE powder matter into a certain desired shape, such as occurs in gel spinning processes.

In this swelling stage, it is desired that the time that is required to achieve the diffusion of the solvent between the polymeric chains as short as possible, which amongst others contributes to optimisation of process economics. A further target is to enable a desirably large quantity of the solvent to diffuse between the polymeric chains, which is believed to contribute to improved processing of the gel during the spinning process, and a more homogeneous solution.

The inventors have now developed an ultra-high molecular weight polyethylene (UHMWPE) powder having a BET specific surface area of ≥0.50 m²/g as determined in accordance with ISO 9277 (2010).

Such UHMWPE powder allows for preparation of a gel solution comprising the powder to a desired swelling ratio at moderate temperatures within a reduced swelling period. Being able to prepare such gel solution having such desired swelling ratio under such temperature and reduced time conditions is believed to contribute to a reduction of degradation of the UHMWPE polymer molecules, and as a result thereof to an improvement of the quality of fibres that are produced using the gel solution of the UHMWPE powder. It is believed that such UHMWPE powder displays a reduced quantity of fibrillated segments, thereby rendering it more capable of absorption of solvent in the area between the molecules.

It is particularly preferred that the BET specific surface area of the UHMWPE powder is ≥0.60 m²/g, more preferably ≥0.70 m²/g. Preferably, the BET specific surface area of the UHMWPE powder is ≥0.50 and ≤2.00 m²/g, more preferably ≥0.60 and ≤1.50 m²/g, even more preferably ≥0.70 and ≤1.50 m²/g.

The UHMWPE powder according to the invention may for example be prepared via a slurry polymerisation process, in which a reaction mixture comprising ethylene and optionally α-olefin comonomers are exposed to polymerisation conditions in the presence of a catalyst. The reaction mixture may consist of ethylene, or may comprise ethylene and α-olefin comonomer, such as for example 1-butene, 4-methyl-1-pentene, 1-hexene, and 1-octene. For example, the reaction mixture may consist of ethylene and ≥0.01 and ≤10.00 mol % of α-olefin comonomer, preferably ≥0.01 and ≤2.00 mol % of α-olefin comonomer. The α-olefin comonomer is preferably selected from 1-butene, 4-methyl-1-pentene, 1-hexene, and 1-octene, particularly preferably from 1-butene and 1-hexene.

The slurry polymerisation process is preferably operated at a temperature of between 20° C. and 200° C., preferably between 20° C. and 120° C., more preferably between 60° C. and 100° C. The slurry polymerisation process is preferably operated at a pressure of between 0.2 and 4 MPa. Preferably, the slurry polymerisation process is operated at a temperature of between 60° C. and 100° C. at a pressure of between 0.2 and 4 MPa.

The slurry polymerisation process preferably involves the use of a diluent for the reaction mixture. Such diluent may for example be a compound selected from alkanes, cycloalkanes, and alkyl aromatic compounds, such as for example propane, isobutane, pentane, hexane, heptane, n-octane, iso-octane, cyclohexane, methylcyclohexane, toluene, xylene, ethylbenzene, isopropylbenzene, ethyltoluene, n-propylbenzene, and diethylbenzene. A particular suitable example of a diluent for use in slurry polymerisation processes for production of UHMWPE is hexane.

The slurry polymerisation process for the production of UHMWPE involves the use of a catalyst. Such catalyst may for example be a catalyst of the Ziegler-Natta family of catalysts, or may be a single-site catalyst. For example, a suitable catalyst may be a catalyst that comprises a reaction product of a hydrocarbon solution comprising an organic magnesium compound such as Mg(OC₂H₅)₂, and an organic titanium compound such as Ti(OC₄H₉)₄, with a solution comprising a halo-aluminium compound selected from aluminium trichloride, ethyl aluminium dibromide, ethyl aluminium dichloride, propyl aluminium dichloride, n-butyl aluminium dichloride, isobutyl aluminium dichloride, diethyl aluminium chloride, and diisobutyl aluminium chloride, and a halo-silicon compound such as for example SiCl₄.

The UHMWPE may for example have an intrinsic viscosity (IV) of ≥10.0 dl/g, preferably ≥10.0 and ≤40.0 dl/g, as determined in accordance with ISO 1628-3 (2010). Particularly preferably, the UHMWPE has an IV of ≥20.0 dl/g, more preferably ≥20.0 and ≤40.0 dl/g. it is further preferred that the UHMWPE has a viscosity-average molecular weight (Mᵥ) of ≥2.0·10⁶ g/mol, more preferably of ≥2.0·10⁶ and ≤10.0·10⁶ g/mol, as determined in accordance with ASTM D4020 (2011).

The UHMWPE may for example have a density of ≥920 and ≤975 kg/m³, preferably of ≥920 and ≤960 kg/m³, more preferably of ≥920 and ≤940 kg/m³, as determined in accordance with ASTM D792 (2008). The UHMWPE powder may for example have a bulk density of ≥300 kg/m³, preferably of ≥300 and ≤600 kg/m³, more preferably of ≥400 and ≤550 kg/m³, even more preferably of ≥450 and ≤550 kg/m³, as determined in accordance with ISO 60 (1977).

The UHMWPE powder preferably has an average particle size D₅₀ of ≤250 μm, preferably of ≥100 and ≤250 μm, more preferably of ≥100 and ≤200 μm, even more preferably of ≥100 and ≤175 μm, as determined in accordance with ISO 13320 (2009).

In a certain of its embodiments, the invention also relates to a process for the preparation of a UHMWPE gel solution, wherein the process comprises in this order the steps of:

(a) providing a quantity of a UHMWPE powder according to the invention;

(b) providing a quantity of a solvent; and

(c) performing a swelling step by mixing (a) and (b) at a temperature of between 100 and 150° C. for a period of between 10 and 25 minutes.

Preferably, the solvent is selected from tetralin, decalin, kerosene and paraffin oil. It is particularly preferred that the solvent is paraffin oil or decalin.

It is further also preferred that the UHMWPE powder accounts for ≥5.0 and ≤30.0 wt %, more preferably ≥5.0 and ≤20.0 wt %, of the total weight of the UHMWPE powder and the solvent combined. It is preferred that the preparation of the UHMWPE gel solution is performed at temperature of between 120° C. and 140° C., preferably between 120° C. and 130° C. It is preferred that the swelling step is performed during a period of between 10 and 20 minutes.

The invention also relates to a gel solution comprising a UHMWPE powder according to the invention. It is preferred that the gel solution comprises ≥5.0 and ≤30.0 wt %, more preferably ≥5.0 and ≤20.0 wt % of the UHMWPE powder with regard to the total weight of the gel solution. Particularly preferably, the gel solution is a system comprising a solvent selected from tetralin, decalin, kerosene and paraffin oil, and the UHMWPE powder.

The UHMWPE powder in the gel solution according to the invention may for example comprise an absorbed quantity of solvent such that the powder has a swelling ratio Q of at least 3.0, preferably ≥3.0 and ≤5.0, wherein the swelling ratio represents the ratio of the weight of the UHMWPE powder after having been subjected to a swelling step vs. the weight of the UHMWPE powder prior to the swelling step.

The invention also relates in a certain embodiment to a process for the production of gel-spun UHMWPE fibres comprising in this order the steps of:

(i) processing the gel solution according to the invention in an extruder;

(ii) extruding the gel solution through a spinneret to obtain spun filaments;

(iii) cooling the spun filaments to obtain solvent-containing gel filaments;

(iv) removing the solvent from the solvent-containing gel filaments to obtain UHMWPE filaments; and

(v) drawing the UHMWPE filaments at a temperature of between 80 and 150° C. to obtain UHMWPE fibres.

The drawing step (v) may for example be performed in a single drawing stage, in two consecutive drawing stages, or in three consecutive drawing stages, wherein the temperature is increased in each subsequent stage, preferably wherein the drawing step (v) is performed in three consecutive drawing stages wherein the temperature in the first stage is between 80° C. and 100° C., in the second stage between 100° C. and 120° C., and in the third stage between 110° C. and 150° C.

It is preferred that the extruder is a twin-screw extruder, preferably wherein the extrusion is performed at a temperature of between 250° C. and 300° C., preferably between 260° C. and 290° C. The drawing may for example be performed in a continuously operating oven, wherein the UHMWPE filaments as obtained from step (iv) are subjected to heat and to a stretching force to induce the orientation of the molecules in the fibre. For example, the stretching force may be so that the draw ratio, which is to be understood to be the ratio of the length of a weight unit of fibre after being subjected to the drawing step (v) vs the length of that weight unit of fibre prior to being subjected to step (v), is ≥20, preferably ≥20 and ≤80, more preferably ≥30 and ≤50.

The invention also relates to a UHMWPE fibre produced using the UHMWPE powder according to the invention, the gel solution according to the invention, or the process according to the invention. The invention also encompasses articles comprising the UHMWPE fibre, such as fibres, ropes, nets, non-woven textiles, woven textiles, and composites comprising such woven textiles.

Further in another embodiment, the invention relates to the use of an UHMWPE powder having a BET specific surface area of ≥0.50 m²/g as determined in accordance with ISO 9277 (2010) for reducing the swelling duration to achieve a swelling rate of 3.0 at a given temperature of between 120° C. and 140° C.

The invention will now be illustrated by the following non-limiting examples.

Preparation of UH powders according to the invention

A catalyst for the manufacture of UH powder was prepared according to the method as set out below.

To a 3 l round bottom flask equipped with a stirrer, a dropping funnel and a water cooler, 185 g of Mg(OC₂H₅)₂ (1.62 mol) as a solid and 275 ml of Ti(OC₄H₉)₄ (0.799 mol) as a liquid were added, both at room temperature (20° C.). The dropping funnel was filled with 2792 ml of hexane. The mixture of Mg(OC₂H₅)₂ and Ti(OC₄H₉)₄ in the round bottom flask was heated to a temperature of 180° C. and stirred at 300 rpm for 1.5 hours. A clear liquid was obtained. The mixture was then cooled down to 120° C. The hexane was added slowly whilst the solution was kept at a temperature of 120° C. After the hexane was added to the solution completely, the solution was cooled down to room temperature. The resulting solution comprising the precursor adduct was stored under nitrogen.

To a 1 l. baffled glass reactor, 400 ml hexane, 17.3 ml SiCl₄ (151 mmol) and 3.5 ml 50 wt % ethylaluminium dichloride (EADC) (12 mmol) in hexane was added. The reactor was stirred at 1700 rpm. To this mixture, 200 ml of the solution obtained above in hexane (20 wt % precursor in hexane, corresponding to 50 mmol) was added to the reactor during a period of 4 hours, while maintaining the stirring speed at 1700 rpm. Subsequently, the suspension was refluxed at hexane boiling temperature of 69° C. for 2 hours under maintained stirring at 1700 rpm, after which it was cooled to 20° C. under stirring at 250 rpm. The obtained catalyst slurry was filtered through a P4 filter and washed 6 times with each 500 ml of hexane. The resulting catalyst has an average particle size D₅₀ of 3.80 μm and a span of 1.00.

Using the catalysts that was prepared as per the above, ethylene polymerisation experiments were conducted to obtain UH powders according to the invention. In a continuously operated 20 l. CSTR reactor filled to 75% of its volume with hexane as diluent, ethylene was polymerised. The concentration in the gas cap of the reactor was monitored by gas chromatography. The level of the liquid/polymer slurry in the reactor was maintained by controlling the discharge quantity and frequency and the supply of make-up reactants. The reactor was heated to a polymerisation temperature as presented in the table below. The polymerisation was initiated by providing ethylene under continuous flow whilst constantly dosing the catalyst. By controlling the quantity of catalyst provided per quantity of reacted monomers, the catalyst yield and the polymer particle size of the obtained UH powder product can be steered. The catalyst was provided in such quantities as to result in a polymer particle size D₅₀ of ca. 140-160 μm. During the reaction, the contents of the reactor were subjected to stirring at 950 rpm. Triisobutyl aluminium was added to the reactor in such amount that the concentration of aluminium in the outlet slurry of the reactor was kept at 40 ppm. An antifouling agent (Statsafe 6633) was continuously added to the reactor in such an amount that the concentration of the antifouling agent was maintained at 80 ppm in the slurry.

The characteristics of the polymerisation experiments of the inventive example and of the UH powders produced as a result of these experiments are provided in the following table.

| Example | I-1 | I-2 | I-3 |
|---|---|---|---|
| Ethylene pressure (bar) | 2.4 | 1.8 | 2.2 |
| Polymerisation temperature (° C.) | 80 | 75 | 75 |
| Catalyst yield (kg polymer/g catalyst) | 31 | 24 | 18 |
| Hydrogen/ethylene molar ratio | 0.001 | 0 | 0.002 |
| 1-butene/ethylene molar ratio | 0.014 | 0.002 | 0.001 |
| Density (kg/m³) | 925 | 927 | 927 |
| Bulk density of produced UH powder | 490 | 500 | 509 |
| (kg/m³) | | | |
| Average particle size D₅₀ (μm) | 149 | 143 | 144 |
| Elongational stress (N/mm²) | 0.23 | 0.42 | 0.45 |
| Intrinsic viscosity (IV) (dl/g) | 21.7 | 30.5 | 28.8 |
| BET surface area (m²/g) | 0.78 | 0.86 | 0.54 |

Wherein:

The bulk density of the UH powders was determined in accordance with ISO 60 (1977);

The density is determined in accordance with ASTM D792 (2008);

The average particle size D₅₀ is the average particle size of the UH powder particles as determined in accordance with ISO 13320 (2009);

The elongational stress was measured according to ISO 11542-2 (1998) at 150° C. over a 10 minute period. Elongational Stress is understood as the stress that is necessary to stretch a test rod of the material to be tested by exactly 600% at a temperature of 150° C. in a suitable heat transfer medium within 10 minutes after starting the measurement. For measurement of the elongational stress, the UH powders of each experiment were shaped into test specimens by compression moulding at 210° C. followed by punching out test specimens according to ISO/CD 11542-2.4. The thus obtained specimens were tested according to Annex A of ISO 11542-2 (1998).

The powders as prepared according to the invention were analysed to identify the intrinsic viscosity and the BET surface area. The intrinsic viscosity (IV) was determined according to the method of ISO 1628-3 (2010). The BET surface area (BET) was determined according to the method of ISO 9277 (2010). Properties of the UH powders of the examples are presented in the table below.

Further, a number of commercially UH powders were used as comparative examples to demonstrate the effect of the invention, the analysis of which is presented in the table below.

| Sample | IV | BET |
|---|---|---|
| C-1 | 21.0 | 0.26 |
| C-2 | 21.5 | 0.23 |
| C-3 | 26.4 | 0.20 |

In the table above, C-1 is a sample of grade SLL-4, obtainable from Shanghai Lianle; C-2 is a sample of grade GUR4022, obtainable from Celanese; and C-3 is a sample of grade UH805, obtainable from Jiujiang Xinxing.

The above samples 11 through I-3 and C-1 through C-3 were used in swelling experiments. The UH powder samples were in each case added to a 250 ml three-necked round-bottomed flask containing 150 ml paraffin oil to reach a concentration of 1 wt % UHMWPE in oil. The grade of paraffin oil used was No. 70.

The round-bottomed flask was heated in a thermostatic oil bath to a temperature of as indicated in the table below under constant stirring using a mechanical stirrer. The temperature was maintained throughout the swelling period. The homogeneous suspension of the UH powder in oil changed after a period t₁ (expressed in the table below in minutes) into the form of white flocs. t₁ was determined by visual observation of the formation of the flocs. In the context of the present invention, t₁ is reflects the swelling time. The contents of the flask were then poured into a Breitbart funnel to remove extra solvent. The weight of the swollen UHMWPE was then measured as W₁. The solvent that was remaining as absorbed in the swollen UHMWPE was then extracted with dichloromethane under ultrasonic conditions for 30 minutes. After three extractions, the extracted UHMWPE sample was dried in a vacuum oven at 70° C. for 4 hours. The dry UHMWPE sample was then weighed and recorded as W₂. The swelling ratio Q was calculated by the equation Q=W₁/W₂.

| | Swelling | | | | |
|---|---|---|---|---|---|
| Sample | temperature (° C.) | 128 | 130 | 132 | 134 |
| I-1 | t₁ (min) | — | — | — | — |
| | Q | — | — | — | — |
| I-2 | t₁ (min) | 19.21 | 17.16 | 15.47 | 12.02 |
| | Q | 1.887 | 2.161 | 3.383 | 3.085 |
| I-3 | t₁ (min) | 23.01 | 18.23 | 13.42 | 12.19 |
| | Q | 1.549 | 2.220 | 2.932 | 4.028 |
| C-1 | t₁ (min) | 26.30 | 19.50 | 15.30 | 14.15 |
| | Q | 1.429 | 2.000 | 2.474 | 3.533 |
| C-2 | t₁ (min) | 36.20 | 22.00 | 15.30 | 14.20 |
| | Q | 1.442 | 1.444 | 1.471 | 3.158 |
| C-3 | t₁ (min) | 38.59 | 25.27 | 18.44 | 14.44 |
| | Q | 1.378 | 1.465 | 2.308 | 2.529 |

1. An ultra-high molecular weight polyethylene (UHMWPE) powder having a BET specific surface area of ≥0.50 m²/g as determined in accordance with ISO 9277 (2010).

2. The UHMWPE powder according to claim 1 wherein the UHMWPE has an intrinsic viscosity (IV) of ≥10.0 dl/g as determined in accordance with ISO 1628-3 (2010).

3. The UHMWPE powder according to claim 1, wherein the UHMWPE has a viscosity-average molecular weight (Mᵥ) of ≥2.0·10⁶ g/mol, as determined in accordance with ASTM D4020 (2011).

4. The UHMWPE powder according to claim 1, wherein the UHMWPE powder has an average particle size D₅₀ of ≤250 μm, as determined in accordance with ISO 13320 (2009).

5. A process for preparation of a UHMWPE gel solution comprising in this order the steps of:
(a) providing a quantity of a UHMWPE powder according to claim 1;
(b) providing a quantity of a solvent; and
(c) performing a swelling step by mixing (a) and (b) at a temperature of between 100 and 150° C. for a period of between 10 and 25 minutes.

6. A gel solution comprising a UHMWPE powder according to claim 1.

7. The gel solution according to claim 6, wherein the gel solution comprises ≥5.0 and ≤20.0 wt % of the UHMWPE powder with regard to the total weight of the gel solution.

8. The gel solution according to claim 6, wherein the solution is a system comprising a solvent selected from tetralin, decalin, kerosene and paraffin oil, or the UHMWPE powder.

9. The gel solution according to claim 6, wherein the UHMWPE powder comprises an absorbed quantity of the solvent such that the powder has a swelling ratio Q of at least 3.0, wherein the swelling ratio represents the ratio of the weight of the UHMWPE powder after having been subjected to a swelling step versus the weight of the UHMWPE powder prior to the swelling step.

10. A process for the production of gel-spun UHMWPE fibres comprising in this order the steps of:
(i) processing the gel solution according to claim 6 in an extruder;
(ii) extruding the gel solution through a spinneret to obtain spun filaments;
(iii) cooling the spun filaments to obtain solvent-containing gel filaments;
(iv) removing the solvent from the solvent-containing gel filaments to obtain UHMWPE filaments; and
(v) drawing the UHMWPE filaments at a temperature of between 80 and 150° C. to obtain UHMWPE fibres.

11. The process according to claim 10, wherein the drawing step (v) is performed in a single drawing stage, in two consecutive drawing stages, or in three consecutive drawing stages, wherein the temperature is increased in each subsequent stage.

12. The process according to claim 10, wherein the extruder is a twin-screw extruder.

13. An UHMWPE fibre produced using the UHMWPE powder according to any one of claim 1.

14. An article comprising the UHMWPE fibre according to claim 13, wherein the article is selected from fibres, ropes, nets, non-woven textiles, woven textiles, and composites comprising such woven textiles.

15. (canceled)

16. An UHMWPE fibre produced using the gel solution according to claim 6.

17. An UHMWPE fibre produced using the process of claim 10.
